(19) United States
(12) Patent Application Publication
(10) Pub. No.: US 2010/0056253 A1
(43) Pub. Date: Mar. 4, 2010

(54) GAMING MACHINE

(75) Inventor: Heath J. Lewis, Houston, TX (US)

Correspondence Address: CONLEY ROSE, P.C.;David A. Rose, P. O. BOX 3267, HOUSTON, TX, 77253-3267, US

(73) Assignee: REVEAL TECHNOLOGY CORPORATION, Austin, TX (US)

(21) Appl. No.: 12/550,802

(22) Filed: Aug. 31, 2009

Related U.S. Application Data
(60) Provisional application No. 61/092,962, filed on Aug. 29, 2008.

(51) Int. Cl. A63F 9/24; A63F 13/00

(52) U.S. Cl. 463/20; 463/30; 463/43

(57) ABSTRACT

Gaming machine. At least some of the illustrative embodiments are gaming machines including a processor, a display device, and a memory device. The memory device configured to store a program code that when executed by the processor causes the processor to, before a player activates the game, generate an outcome for a play of a game on the gaming machine. The program code further causes the processor to, before a player activates the play of the game, notify the player by way of the display device as to whether the upcoming game will be a winner or loser.

### CROSS-REFERENCE TO RELATED APPLICATIONS

This application claims the benefit of provisional application Ser. No. 61/092,962 filed Aug. 29, 2008, titled “A Gaming Machine”, which provisional application is incorporated by reference herein as if reproduced in full below.

### BACKGROUND

Gaming machines enable a player to play a game (e.g., a slot game, a video poker game, or a video blackjack game). For example, gaming machines may be placed at locations such as a casino, a restaurant bar, an airport, or an arcade. In some cases, the gaming machines enable a player to wager on the game, and the gaming machines provide an award if the player wins the game.

Any mechanisms which provide initial consumer interest in one gaming machine over another are highly sought after by gaming companies.

### BRIEF DESCRIPTION OF THE DRAWINGS

For a detailed description of various embodiments, reference will now be made to the accompanying drawings in which:

FIG. 1 illustrates a gaming machine in accordance with at least some embodiments;

FIG. 2 illustrates a control system for the gaming machine in accordance with at least some of the embodiments;

FIG. 3 illustrates a progressive gaming system in accordance with at least some of the embodiments; and

FIG. 4 illustrates a method in accordance with at least some of the embodiments.

### NOTATION AND NOMENCLATURE

Certain terms are used throughout the following description and claims to refer to particular system components. As one skilled in the art will appreciate, gaming companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system” or “subsystems” within the system.

### DETAILED DESCRIPTION

The various embodiments disclosed herein are discussed in the context of gaming machines. The discussion of any embodiment in relation to gaming machines is meant only to be illustrative of that embodiment, and not intended to intimate that the scope of the disclosure, including the claims, is limited to that embodiment.

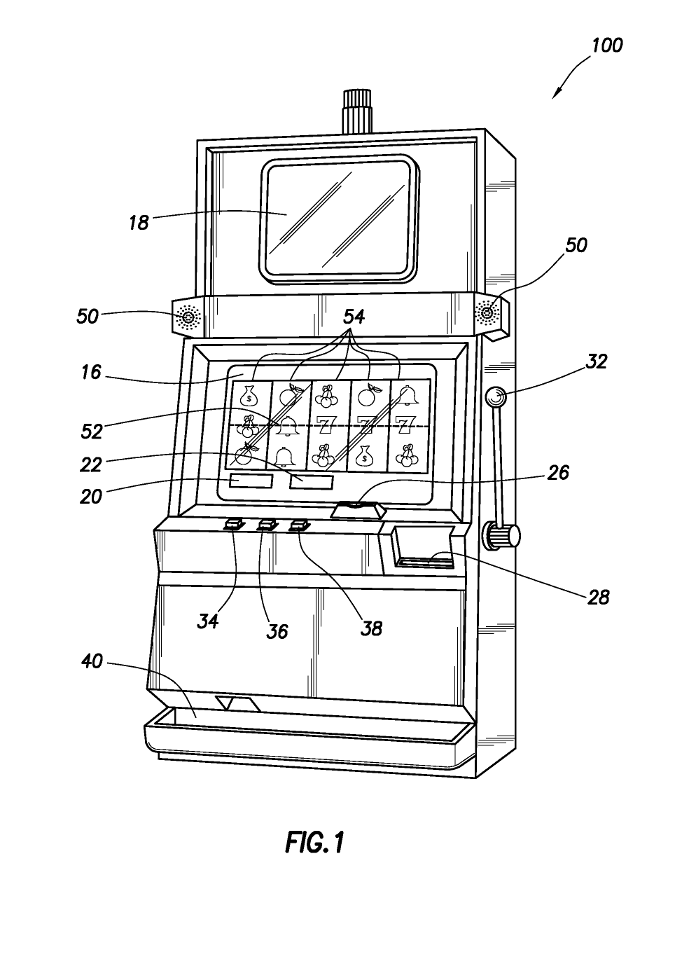

FIG. 1 illustrates a gaming machine 100 in accordance with at least some embodiments. The gaming machine 100 may be operated by a player while either standing or sitting. In particular, the gaming machine 100 comprises a plurality of display devices 16 and 18, and speakers 50. In at least some embodiments, an upper display device 18 (e.g., a monitor, a television display, or a liquid crystal display) displays a gaming method and a payout table, and a lower display device 16 (e.g., a monitor, a television display, or a liquid crystal display) displays a game. For the purpose of explanation, FIG. 1 illustrates the lower display device 16 with a slot game and a payline 52, but other games may be equivalently implemented. In yet still other embodiments, there may be more than one payline 52, and the payline 52 may be vertical, circular, diagonal, angled or any combination thereof. For an illustrative slot machine game, the lower display 16 also displays a plurality of reels 54 and each of the plurality of reels 54 displays a plurality of symbols (e.g., bells, hearts, fruits, numbers, letters, bars or any other image).

In at least some embodiments, the gaming machine 100 comprise a payment acceptor such as a coin slot 26 (i.e., for accepting coins or tokens) and a bill acceptor 28 (i.e., for accepting paper money, ticket or voucher). In other embodiments, the gaming machine 100 may include readers to read credit cards, debit cards or a player card (i.e., a card coded with a player's identification, credit totals and other relevant information). When a player funds the gaming machine 100 by way of the payment acceptors, a credit display 20 displays a player's current number of credits, cash, or account balance or the equivalent. In some embodiment, an input device such as a pull arm 32 or a play button 34 is used by the player to interact with the gaming machine 100. In some embodiments, the lower display device 16 is a touch-screen input device to enable the player to interact with the gaming machine 100. Pushing an activation button 36 enables the player to activate the game displayed in the lower display device 16 and a display area 22 displays an amount the player commits to activate the game. In some embodiments, the player can increase the amount used to activate the game by repeatedly pushing the activation button 36. The player may push cash out button 38 to receive a cash payment or other suitable form of payment, such as coins or tokens in a coin payout tray 40.

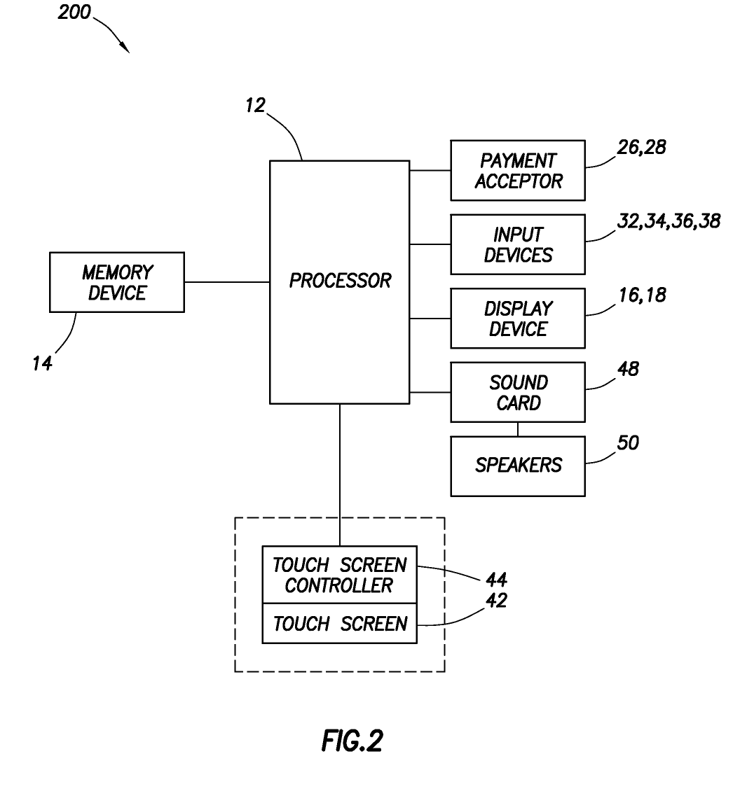

FIG. 2 illustrates a control system 200 of the gaming machine 100 in accordance with at least some of the embodiments. The control system 200 resides within the gaming machine 100, and the control system 200 comprises a processor 12 (e.g., a microprocessor or an application-specific integrated circuit (ASIC)) electrically coupled to a memory device 14. The memory device 14 may be any memory device including random access memory (RAM), read only memory (ROM), flash memory or any other magnetic, optical or semiconductor memory. The memory device 14 stores a program code executable by the processor 12 to control the gaming machine 100. In alternative embodiments, the control system 200 comprises a plurality of processors and a plurality of memory devices. The memory device or devices store data such as image data, event data, player input data, random or pseudo-random number generators, pay-table data and applicable game rules that relate to the play of the gaming machine 100.

In at least some embodiments, the processor 12 is coupled to the display devices 16 and 18, and the processor 12 controls the display on the upper display device 18 and the lower display device 16. The processor 12 is also coupled to speakers 50 by way of the sound card 48. The processor 12 couples with payment acceptors 26 and 28 to determine the amount of funds entered by the player. The processor 12 further couples to the plurality of input devices 32, 34, 36 and 38, and the processor 12 activates the game displayed in the lower display device 16 of the gaming machine 100. In other embodiments, upon receiving appropriate funding, processor 12 begins the game automatically. In other embodiments, the processor 12 couples to a touch-screen controller 44 to receive inputs from the touch screen 42.

Consider, for purpose of explanation, that the game displayed in the lower display device 16 of the gaming machine 100 shows an illustrative slot game. As previously discussed, a slot game comprises a payline 52 and a plurality of reels 54, and each of the plurality reels 54 comprise a plurality of symbols (e.g., bells, hearts, fruits, numbers, letters, bars or any other image). To initiate a slot game, the player first funds the gaming machine 100 by way of the payment acceptors (i.e., the coin slot 26 and the bill acceptor 28), and subsequent to the funding of the gaming machine 100, the player pushes the activation button 36 to activate the slot game. In some embodiments, the appropriate activation amount is the smallest denomination (e.g., 25¢, 50¢, or $1) that is requisite to play the slot game. In other embodiments the player can increase the activation amount (i.e., in multiples of the smallest denomination) by repeatedly pushing the activation button 36. Next, the player pulls the pull arm 32 or pushes the play button 34 to start the illustrative slot game and to start spinning the reels 54. The gaming machine 100 randomly generates the outcome of the slot game, but as discussed more fully below the random generation occurs prior to the player activating the game. The gaming machine 100 utilizes a random number generator in conjunction with the processor 12 to generate an outcome for the slot game.

The random number generator generates a random number for each of the reels 54. The random number generated for each of the reels 54 corresponds to a symbol on the reel. When each of the reels 54 stop spinning, the symbol corresponding the random number for the reel is displayed in the lower display device 16. Therefore, the outcome displayed on the lower display device 16 is a random combination of symbols on the reels 54. Use of a random number generator ensures that the odds of winning are equal.

The gaming machine 100 provides awards when the reels 54 stop spinning and if a specified combination of the symbols occur on the payline 52 (i.e., the payline 52 passes through the specified combination of symbols). In alternative embodiments, the gaming machine 100 provides awards to the player based on a number of specified symbols which are generated in active symbol positions on the requisite number of adjacent reels 54 (i.e., not on payline 52). Stated otherwise, if a winning combination of symbols is generated on the reels 54 and displayed on the lower display device 16, the gaming machine 100 provides the player with an award. The awards provided to the player are determined based on a pay-table stored in the memory 14 of the gaming machine 100. In some embodiments, the gaming machine 100 provides awards to the player in the form of coins, tokens, credit slips, or funds a player card.

Unlike related art slot machines and other gaming machines, in the various embodiments the player knows before activating a game whether the player is going to win or lose a play of the game. In particular, and as alluded to above, prior to activation of game by pressing of the activation button 36, the gaming machine calculates the outcome of the as-yet activated game and displays an indication of whether the as-yet activated game will be a winner or loser). In some embodiments, the gaming machine 100 displays the amount of the award that will be provided on the next play (including zero award amounts). In other embodiments, the gaming machine 100 displays the actual result of the as-yet activated play. For example, in the case of the illustrative slot game, the gaming machine could display the monetary award that will be the result of the play of the game, the final symbols that will be displayed upon the next activation, both the award and the symbols, or some other indication of the guaranteed outcome.

In particular, in accordance with at least some embodiments, the gaming machine 100 utilizes the random number generator to generate a combination of symbols on the reels 54 that will be the outcome for a play of the illustrative slot game, but in this example, does not display the symbols. Next, the gaming machine 100 determines an award for the play of the as-yet activated slot game, and the award determined is displayed on the upper display device 18 of the gaming machine 100, all before the player activates the play. In other embodiments, the award is displayed on the lower display device 16 or any other suitable location. Subsequent to the display of the award for the play, the player pushes the activation button 36 to activate the play of the game (i.e., already knowing that the play will result in a win or a loss), and the player pulls on the pull arm 32 or pushes the play button 34 to start the play of the illustrative slot game.

When the reels 54 stop “spinning,” the outcome generated prior to activation is displayed in the lower display device 16 and the gaming machine 100 provides the player with the award for the play displayed on upper display device 18. Thus, the player knows before activating a play of the slot game whether the outcome of the play will result in a win (i.e., an award will be provided to the player) or a loss (i.e., an award will not be provided to the player). In some cases, the actual award is known beforehand, in some cases the result of the game symbols is known beforehand, or both. The balance of this specification discusses the win/lose information being provided to the player beforehand to be the award value, but other information regarding the win/lose guaranteed outcome may be equivalently used.

FIG. 3 illustrates a progressive gaming system 300 in accordance with at least some embodiments. In particular, FIG. 3 illustrates the progressive gaming system 300 with a plurality of gaming machines 100 coupled to a central controller 56 through a network link 58 (e.g., local area network, or wide area network). The plurality of gaming machines 100 are proximate to each other and the central controller 56 is located within the same location as the gaming machines 100. The central controller 56 allocates into a progressive jackpot a portion of the activation amount placed at each of the gaming machines 100. Thus, the progressive jackpot continues to grow until the progressive jackpot is provided to a player. In some embodiments, the central controller 56 also generates, before activation by the player, the outcome of a play of the game on each of the plurality of gaming machines 100. For example, if the game is a slot game then the central controller 56 utilizes a random number generator to generate an outcome for a play of the slot game on each of the plurality of gaming machines 100. The central controller 56 determines an award for the play of the slot game on each of the plurality of gaming machines 100. Each of the plurality of gaming machines 100 display the award for the play of the slot game before the player activates the play of the slot game. Next, the player pushes the activation button 36 to place to activate the play of the slot game (i.e., already knowing whether the play will result in a win or a loss), and the player pulls the pull arm 32 or pushes the play button 34 to start the play of the slot game.

In alternative embodiments, each of the plurality of gaming machines 100 generate an outcome for a play of the game on the gaming machine 100 and determine an award for the play of the slot game. The central controller 56 receives the outcome generated for the play at the gaming machine 100, and the central controller 56 determines whether outcome generated for the play is the progressive jackpot winning outcome. Each of the plurality of gaming machines 100 display the award (i.e., the progressive jackpot or otherwise) for the play of the slot game before the player activates the play of the slot game.

In other embodiments, the gaming machine 100 is a multi-denomination gaming machine. The multi-denomination gaming machine enables the player to choose a particular denomination, from a list of denominations (e.g., 25¢, 50¢, or $1), that will be requisite to play a game on the gaming machine. Based on the denomination the player chooses, the multi-denomination gaming machine determines an award for a play of the game, and the multi-denomination gaming machine displays the award for the play before the player activates the play of the game. In other embodiments, the multi-denomination gaming machine displays a list of denominations and a list of corresponding awards for a play of the game. The player then chooses the denomination and places an activation amount for the play. The multi-denominational embodiments differ from the other embodiments in that only one amount may be committed to activate the game, but the player may choose from different activation amounts on the same machine.

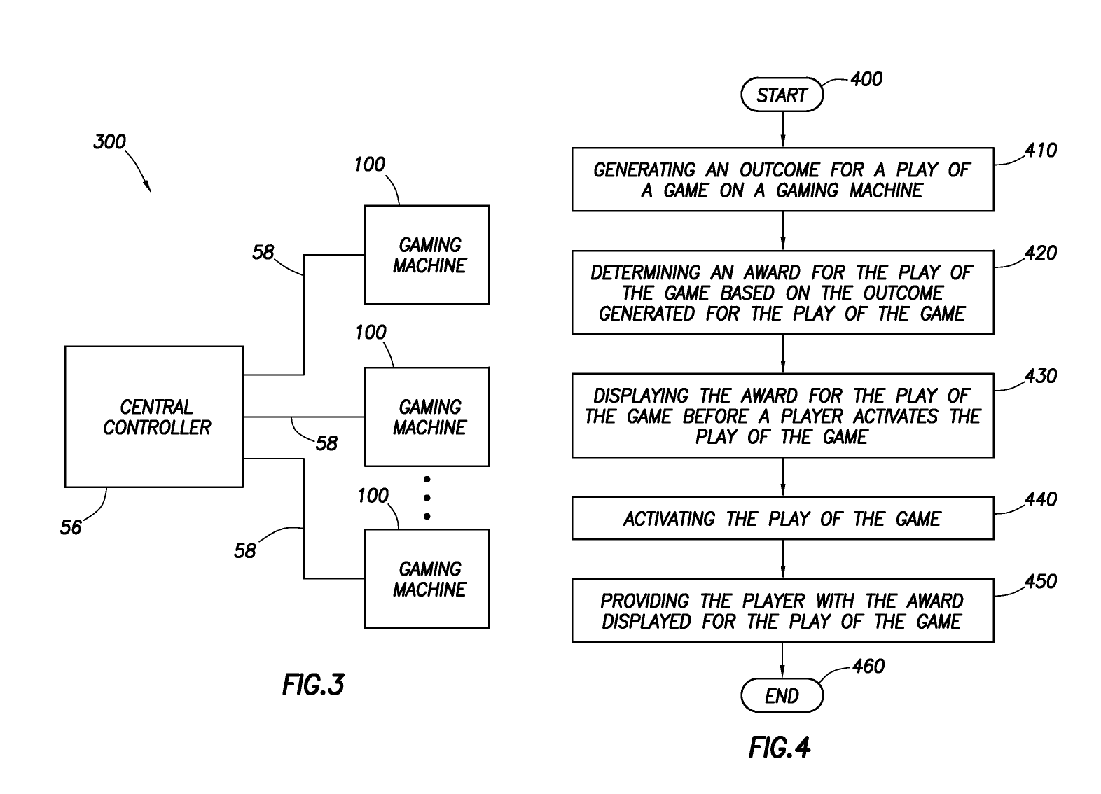

FIG. 4 illustrates a method in accordance with at least some embodiments. In particular, the method starts (block 400) and moves to generating an outcome for a play of a game on a gaming machine (block 410). In at least some embodiments, the outcome is generated randomly based on a random number generator. Next, an award for the play of the game is determined based on the outcome generated for the play of the game (block 420). Thereafter, the award for the play of the game is displayed before a player activates the play of the game (block 430). In at least some embodiments, the award in displayed on a display device of the gaming machine. Next, the player activates the play of the game (block 440). Finally, the player is provided with the award displayed for the play of the game (block 450) and the method ends (block 460).

The various embodiments discussed to this point are in reference to a physical gaming machine 100; however, in other embodiments the operational aspects described above may be implemented as Internet-based gaming. In particular, in the Internet-based alternative embodiments a player logs onto an Internet site, and provides credits through any suitable mechanism, such as by charging to a credit or debit card. The player then selects a game of interest, such as the illustrative slot game. Software executing on a remote computer system or server determines an outcome of the as-yet activated game, determines the award (if any), and sends a computer-readable page (e.g., hypertext markup language (HTML)) page the computer of the player. The computer-readable page displayed by the player's computer may thus mimic, in some form, the displays 16 and 18 discussed with respect to gaming machine 100. That is, the player's screen may show the award of the as-yet activated game, the outcome of the as-yet activated game, or some other indication of the guaranteed outcome. The player, interfacing by of interface devices such as the player's keyboard or mouse, activates the game by committing credits or other monetary value, initiates game play, and receives the award (e.g., by receiving credit on the player's account). Before the player activates the next game, the remote computer system determines an outcome, determines an award, and sends the computer readable page to the player's computer. Again, if the player so chooses based on the guaranteed outcome, the player activates the game by committing credits or other monetary value, and initiates game play to receive the guaranteed outcome.

Moreover with respect to Internet-based embodiments, progressive jackpots may be implemented based on the number of online and/or physical slots in the progressive pool. Further still, multi-denominational play may likewise be implemented in the Internet-based embodiments.

The above discussion is meant to be illustrative of the principles and various embodiments. Numerous variations and modifications will become apparent to those skilled in the art once the above disclosure is fully appreciated. For example, while the discussion of the various embodiments is directed towards a gaming machine with a slot game, the gaming machine may display other games (e.g., video poker game, video blackjack game, video Keno, or video Bingo). Moreover, while the discussion of the progressive gaming system is directed to a system comprising plurality of gaming machines and central controller located within the same location, in some embodiments that gaming machines and the central controller may be located across various locations. Further still, while random number generates are described with respect to determining an outcome, in other embodiments all possible outcomes (sequence of symbols) could be predetermined (there may be 60 to 100 million such outcomes), and rather than a random number selecting a symbol for each wheel, one of the possible outcomes could be selected. It is intended that the following claims be interpreted to embrace all such variations and modifications.

What is claimed is:

1. A gaming machine comprising:
at least one processor;
at least one display device; and
at least one memory device, the least one memory device configured to store a program code that when executed by the at least one processor causes the processor to, before a player activates the game, generate an outcome for a play of a game on the gaming machine; and
the program code further causes the processor to, before a player activates the play of the game, notify the player by way of the at least one display device as to whether the upcoming game will be a winner or loser.

2. The gaming machine as defined in claim 1 wherein the game is a slot game.

3. A method comprising:
generating an outcome for a play of a game on a gaming machine;
determining an award for the play of the game based on the outcome generated for the play of the game; and
displaying an indication of either the outcome or the award before a player activates the play of the game.

4. The method as defined in claim 1 wherein the game is a slot game.
